(19) United States
(12) Patent Application Publication
(10) Pub. No.: US 2023/0129094 A1
(43) Pub. Date: Apr. 27, 2023

(54) METHOD AND SYSTEM FOR TRAINING A QUERY RANKING MACHINE-LEARNING MODEL TO PROVIDE AN ANSWER FOR A USER QUERY

(71) Applicant: Raffle.ai ApS c/o Suzanne Lauritzen, København K (DK)

(72) Inventors: Suzanne Lauritzen, Klampenborg (DK); Jonas Lyngsø, København Ø (DK); Ole Winther, Hellerup (DK)

(73) Assignee: Raffle.ai ApS c/o Suzanne Lauritzen, København K (DK)

(21) Appl. No.: 17/973,045

(22) Filed: Oct. 25, 2022

Related U.S. Application Data
(60) Provisional application No. 63/271,333, filed on Oct. 25, 2021.

(51) Int. Cl. G06F 16/957; G06F 16/9538; G06N 5/04; G06F 16/9532

(52) U.S. Cl. CPC G06F 16/957; G06F 16/9538; G06N 5/04; G06F 16/9532

(57) ABSTRACT

A computer-implemented method for training a query ranking machine-learning model to provide an answer for a user query in a search engine. The method obtains a first training set and training a query-ranking machine-learning mode and a query generation machine-learning model on the first training set. From a knowledge database, the query generation machine-learning model generates a second training set. The query-ranking machine-learning model filters the second training set and the query-ranking machine-learning model is retrained on the filtered training set. The steps of generating a second training set, filtering the second training set and retraining the query ranking machine-learning model on the filtered training set may be repeated several times.

### CROSS-REFERENCE TO RELATED APPLICATIONS

This application claims the benefit of U.S. Provisional Application No. 63/271,333, filed Oct. 25, 2021, which is hereby incorporated by reference.

### FIELD OF THE INVENTION

The present invention relates to a method for training a query ranking machine-learning model to provide an answer for a user query in a search engine.

### BACKGROUND OF THE INVENTION

An enterprise usually has a large amount of documentation, which may be documents electronically available for the employees of the enterprise. When an employee or another authorized user is searching for a document or an answer in the documentation available for the enterprise using a computer search engine, the user is formulating a query and the computer then searches for a document or an answer for the query in the electronic available documentation. This search traditionally has been based upon keyword matching implemented by sparse search indices. This is usually not very efficient and often do not supply the most relevant answer.

Recently machine-learning methods has been applied to improve search quality. US2021/0157857 discloses a method to generate synthetic queries from customer data for training of document querying machine-learning models. The method includes receiving one or more documents from the user; generating a set of questions from the user documents using a machine-learning model trained to predict a question from an answer. The question and answer pairs may be used to train another machine learning model, for example a document ranking model, a question/answer model, or a frequently asked question (FAQ) model to determine one or more top ranked answers from data for a search query from the user, However, even though this is an improvement over the traditional methods, more efficient training methods for the machine-learning model is desirable for obtaining a still higher quality of the answers provided for the user query.

Hence, an improved method for training a machine-learning model for providing answer to a user query would be advantageous, and in particular a more efficient and/or reliable method would be advantageous.

### OBJECT OF THE INVENTION

It is an object of the present invention to provide an alternative to the prior art.

In particular, it may be seen as an object of the present invention to provide a method for training a machine-learning model for providing an answer to a user query that solves the above mentioned problems of the prior art with finding a high quality answer for the query in the documentation.

### SUMMARY OF THE INVENTION

Thus, the above described object and several other objects are intended to be obtained in a first aspect of the invention by a computer-implemented method for training of a query ranking machine-learning model to provide an answer for a user query in a search engine comprising:
obtaining a first training set comprising queries with associated answers,
training the query ranking machine learning model on the first training set,
training a query generation machine learning model for generating queries from answers based on the first training set,
obtaining a knowledge database, comprising documents and answers,
generating, from the knowledge database with the query generation machine-learning model, a second training set comprising queries with associated answers from the knowledge database,
filtering, with the query ranking machine learning model, the generated queries with associated answers to generate a filtered group of queries with associated answers, the filtered group is one or more of:
   a first filtered group of one or more generated queries with associated answers that the query ranking machine learning model cannot rank correctly,
   a second filtered group of one or more generated queries that that have two or more associated answers, and
   a third filtered group excluding one or more generated queries with associated answers, where for the answers none of the associated generated queries are ranked correctly,
retraining the query ranking machine learning model at least partially based on the filtered group of queries with associated answers from the second training set, and
repeating the generating, filtering and retraining steps zero or more times.

The invention is particularly, but not exclusively, advantageous for obtaining efficient training methods of the query ranking machine learning model to obtain answers of higher quality than known from prior art on user queries.

The training of a query ranking machine learning model (for short hereafter referred to as the ranking model) to provide an answer for a user query is done in several steps. The first step is to train the ranking model on a first training set comprising queries with associated answers. The ranking model is trained to rank queries, providing a score for each query relative to an answer. The input for the ranking model is a query and an answer, the ranking model then generates a score for estimating the relevance between the query and the answer.

The first training set may be obtained by collecting sets of queries and answers developed for different enterprises. These set are usually curated by human annotators.

The preferred used ranking model is based upon the CoIBERT architecture as described in the reference: Khattab, O. & Zaharia, M. (2020), “CoIBERT: Efficient and Effective Passage Search via Contextualized Late Interaction over BERT”.

An answer is a document, a section of a document, any text containing some information, or a generated answer based on a document or a section. A query with an associated answer is a query generated from a section or document, where the section or the document is the associated answer.

The words “answer”, “section” and “document” is used interchangeable in this document.

Generally, a query is a question with a question mark, but it may also be a sequence of one or more words for searching or evaluating an answer. A query is a question or search terms received from a user or generated by question generation. In this document the terms “question” and “query” is used interchangeable.

Queries have in the past been generated and/or annotated manually by human annotators. The sets collected to form the first training set may be queries manually generated for documents or sections of documents by human annotators based on documents from different enterprises.

The knowledge database is a database with all available information from an enterprise; this is electronic available documents for the enterprise. The documents may be all sorts of documents, like pdf-files, word files, excel sheets, or html-files. In an enterprise, there may be a computer system, for instance an intranet, where all the enterprises electronic documents and information is available for the employees of the enterprise. From this knowledge database, the query generation machine-learning model (for short hereafter referred to as the generation model) generates a second training set comprising queries associated to answers from the knowledge base.

Before being able to generate a second training set, the generation model is also trained on the first training set. The generation model is trained to formulate queries that's corresponds to the answers.

By using the generation model to generate queries to answers, a lot more queries can be generated than it is possible to do with human annotators.

After generating queries for the second training set, the second training set is filtered by the ranking model. The ranking model is filtering the second training set and generating a group of filtered queries with associated answers. The method of the invention is receiving an input parameter for which group or groups of queries with associated answers to identify and filter from the second training set.

The first filtered group is identified generated queries that the query ranking machine learning model cannot rank correctly, the second filtered group is generated queries that have two or more associated answers, and the third filtered group is excluding answers that fail to rank any associated generated queries correctly.

Regarding the first group, filtering generated queries that the query-ranking machine-learning model cannot rank correctly, it is computationally cheap to use the generation model to get queries and then rank them with the existing ranking model. These two so-called inference steps only require running the models forward once per query generated. The expensive part is training. We can therefore generate and rank many examples to assemble a set of queries that the ranking model will not answer correctly.

Identifying queries that the ranking model cannot rank correctly is done by ranking a query relative to all sections or answers in the second training set, hereby the section or answer with the highest score is compared to the section or answer that was used to generate the query. If the section or answer with the highest score is not identical to the section or answer used to generate the query, then the query is not ranked correctly. Preferable, when a query is entered, the ranking model should score the section or answer, for which the query originally was derived, as the highest ranked section or answer.

Training the ranking model on these hard queries will boost the ranking performance because:
a. Hard queries are more informative so less is needed to get good performance,
b. for large knowledge bases, we are computationally constrained on how much training data we can use, so focusing on the hard queries can to some degree counter this and
c. avoid training on easy data will also help the model not to overfit to data it already answers correctly.

In short, the hard queries are used to train the ranking model, while the easy queries are excluded by not being selected for the filtered queries.

Regarding the second group, filtering generated queries that that have two or more associated answers, if a generated query for answer i is often associated with answer j by the ranking model and vice versa then, it is an indicator that the two answers are similar. We can therefore let some of the queries have multiple labelled answers, where the labelled answers are correct answers. Thereby, a query can have more than one correct answer or section. Therefore, during training it will be counted as a correct hit, if the highest scoring section or answer is any of the labelled correct answers. This will make the model more robust to redundancy in the knowledge base. Redundancy/false negative is a problem often hampering the performance of the supervised approach to ranking.

Regarding the third group, filtering answers to exclude answers that fail to rank any associated generated queries correctly, if many queries for each section is generated and ranked, then statistics on how often the ranking model will answer queries correctly for each section can be collected. The ranking model may continuously for consecutive training iterations fail to rank associated generated queries high. Sections for which the associated generated queries always fail to rank high will be problematic for different reasons. The section may not contain meaningful content, or complex content that requires manual construction of relevant queries, etc. Therefore, this statistic can be used to zoom in on knowledge base content that requires manual care. Therefore, the third group will consist of data that is ranked correctly, while queries with associated answers, where, for the answers, none of the associated generated queries are ranked correctly, are excluded. The excluded query answer pairs may then be evaluated by a human annotator, who may improve the queries and add the pair to the human curated group of queries for associated answers.

Filtering may further comprise excluding redundant queries from the second training set. Redundant questions are identified by comparing queries, if two queries have a high coincidence in ranking answers, for instance having more than 50% overlap in the top 10 ranking of answers, one of the questions may be excluded from the second training set.

An answer may also be redundant, when comparing generated queries for two answers, and for instance the top ranked answer, the answer with the highest score when querying the ranking model, for the queries coincide, for instance if 100% of the queries, or 80% of the queries ranks the same answer highest, the two answers are redundant and may be removed from the training set and the answers and the questions may be saved for inspection and improvement by a human annotator.

After filtering the second training set, the ranking model is retrained at least partially based on the queries with associated answers from the second training set using the filtered generated queries.

The queries with associated answers may be reviewed by human annotators, especially the queries that not has been included in the filtered data, the human annotator can change queries or delete query answer pairs that are wrong or of low quality.

The steps of generating, filtering and retraining may be repeated a number of times with diminishing performance improvements for each repetition. Beyond one to three repetitions will usually not give any improvements.

The generation model is not retrained, but the generation model is stochastic and therefore it vary its output indefinitely, therefore the generating step is performed and a new second training set is generated for retraining the ranking model.

Recently, learned dense vector representations of queries and knowledge bases matched with inner product similarity have emerged as a competitive approach especially for contextual and natural language queries. The vector representation is obtained from the self-supervised plus fine-tune paradigm: train a large Transformer machine-learning model first as a language model (e.g. BERT) on a large unlabelled dataset and secondly fine-tune the model on the search task using a much smaller labelled dataset of queries and ground truth answer text snippets from the knowledge base.

A transformer machine-learning model is a deep learning model that adopts the mechanism of attention, differential weighing the significance of each part of the input data. The transformer model is described in the reference: Polosukhin et al. “Attention is All You Need” (2017).

US2021/0157857 considers question generation and training of ranking model as a two separate steps with no interaction. However, in all practical situations a preliminary ranking model will be available and can be used to select what generated questions should be used for training the ranking model. This has implications for both the attainable ranking performance and for getting the best possible performance for a limited compute budget. The latter is of big practical importance when working with large knowledge bases.

In this patent, we propose to augment or replace the fine-tuning step with labelled data generated by a conditional generative model, the generation model, which performs query generation: The generative model takes a piece of text, like a section of a document also named an answer, as input and generates queries, such that the text contains information relevant for the query. The generation model is trained on sets of query and ground truth answer text sections. The generated query and answer text can be used either as a supplement to the existing labelled data or entirely replace the labelled data (zero-shot learning). The generated queries may also be curated by human annotators, in order to boost the quality of the queries, and thereby improve the downstream performance of the information retrieval system.

The proposed solution fundamentally changes the workflow for building machine learning based search solutions for individual knowledge bases. To train a high performing model, a number of queries is needed for each answer in the knowledge base. In a minority of use cases, queries can be extracted from historical logs. In the typical case, queries have to be generated by human annotators before the solution is deployed. This is costly and also limits the use of the high performing machine learning based solution to knowledge bases consisting of up to a few hundred answers. With the automatic query generation, there is a substantial cost and time saving and the solution can in principle scale to very large knowledge bases.

Accordingly, the method further comprises retraining of the query ranking machine learning model also is partially based on a group of manually curated queries with associated answers curated by human annotators.

Human annotators can create a group of manually curated queries; this group may contain queries to an associated answer written by the human annotator, or queries that are originally generated by the generation model, but where the human annotator has improved the query.

Curated queries are written, selected, organized, and presented by a human annotator using professional or expert knowledge.

The group of manually curated queries may be added to the group of filtered queries and the combined groups are used for training the ranking model.

Accordingly, the method further comprises the queries with associated answers generated by the query generation machine learning model are curated at least partially by human annotators potentially aided by the filtering of the query ranking machine-learning model and included in the group of manually curated queries with associated answers.

Accordingly, the method further comprises that one or more of the queries with associated answers excluded from the first filtered group, the second filtered group or the third filtered group are curated at least partially by human annotators and included in the group of manually curated queries with associated answers.

Accordingly, the method further comprises a query is ranked correctly when, using the query ranking machine learning model to calculate a score for each answer in a training set relative to the query, the highest scoring answer is the answer associated with the query.

Accordingly, the method further comprises receiving a query from the user of the search engine, and applying the query ranking machine-learning model to process the query for providing an answer to the user.

When using CoIBERT, the knowledge database is indexed offline. When a query is received from a user, the ranking model is used to find an answer from the indexed knowledge database. The knowledge database may be indexed as described in the previous mentioned CoIBERT reference by Khattab and Zaharia using the FAISS data structure. Then to get an answer for a query, the query is run through the BERT part. The indexing method is well known from prior art.

Accordingly, the method further comprises that the knowledge database is obtained by collecting documents and answers from an enterprise document collection.

The knowledge database is a collection of documents for an enterprise. The enterprise, which may be a company, an association, a university or any enterprise with a large collection of documentation. Often an enterprise may have a collection of electronic documentation in an enterprise database accessible through an intranet or similar computer system. It can be difficult to find documents in such a system if it is sparsely indexed. The invention is making such a search for documentation much more efficient.

Accordingly, the method further comprises that the first training set is obtained as a collection of two or more training sets created for a number of enterprises.

By collecting training sets created for a number of enterprises for the first training set and use it for training the generation model, the generation model is trained on data that is typical for an enterprise and therefore, the quality of the training will be higher, than if it was trained on training sets that was made for random data for instance collected on the internet, or from data in public available database of query answer pairs like the MS Marco training set.

Accordingly, the method further comprises that the collection of two or more training sets is created at least partially by human annotators.

The training sets collected for the first training set is often made at least partially by human annotators. In the past without computer aid to generate queries from answers, like sections in a document, such query answer pairs were generated by human annotators for use by search engines. As many such sets has been generated over the years, these sets can now be collected and used for the initial training of the ranking model and the generation model.

Accordingly, the method further comprises that the query generation machine-learning model is comprising a sequence-to-sequence model.

Accordingly, the method further comprises that the query ranking machine-learning model is comprising a language model such as the BERT Transformer model.

Accordingly, the method further comprises that the generating, filtering and retraining steps is repeated zero, one, two, three, four, five or more times.

The step of generating, filtering and retaining is repeated a number of times with a diminishing performance improvement for each repetition. The number of repetitions may be chosen as an input parameter before the run of the method is initiated. The generating, filtering and retraining steps may be repeated zero, one, two, three, four, five or more times. Three times is usually sufficient.

In a second aspect, the invention relates to a computer-implemented search engine for obtaining an answer for a user query by receiving a query from a user and apply a query ranking machine learning model to provide an answer to the user query, the query ranking machine learning model is trained according to claim 1.

In a third aspect, the invention relates to a a system for obtaining an answer for a user query by training a computer-implemented query ranking machine learning model and apply a computer-implemented search engine for receiving a query from a user, and run the query ranking machine learning model to provide an answer to the query; the query ranking machine learning model is trained according to claim 1.

In a fourth aspect, the invention relates to a computer program product being adapted to enable a computer system comprising at least one computer having data storage means in connection therewith to train an query ranking machine-learning model according to the first aspect of the invention, such as a computer program product comprising instructions which, when the program is executed by a computer, cause the computer to carry out the steps of the method of the first aspect of the invention.

This aspect of the invention is particularly, but not exclusively, advantageous in that the present invention may be accomplished by a computer program product enabling a computer system to carry out the operations of the apparatus/system of the first aspect of the invention when down- or uploaded into the computer system. Such a computer program product may be provided on any kind of computer readable medium, or through a network.

The individual aspects of the present invention may each be combined with any of the other aspects. These and other aspects of the invention will be apparent from the following description with reference to the described embodiments.

### BRIEF DESCRIPTION OF THE FIGURES

The method according to the invention will now be described in more detail with regard to the accompanying figures. The figures show one way of implementing the present invention and is not to be construed as being limiting to other possible embodiments falling within the scope of the attached claim set.

FIG. 1 illustrates an overview of the elements in the training method.

FIG. 2 illustrates the training method.

FIG. 3 illustrates that the trained ranking model, it is used to find answers to user queries.

FIG. 4 illustrates the filtering step.

FIG. 5 illustrates an example of an answer.

FIG. 6 illustrates an example of queries associated with more answers.

FIG. 7 illustrates that answers may be associated both with queries generated by the generation model and manually curated queries.

### DETAILED DESCRIPTION OF AN EMBODIMENT

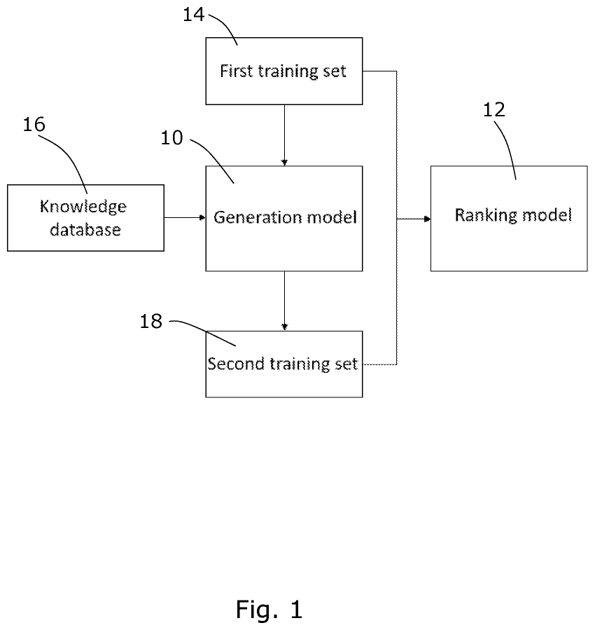

FIG. 1 shows an overview of the elements in the training method. The generation model 10 and the ranking model 12 is both trained on a first training set 14. The generation model 10 is then, from the knowledge database 16, generating a second training set 18, which is used to further train the ranking model 12.

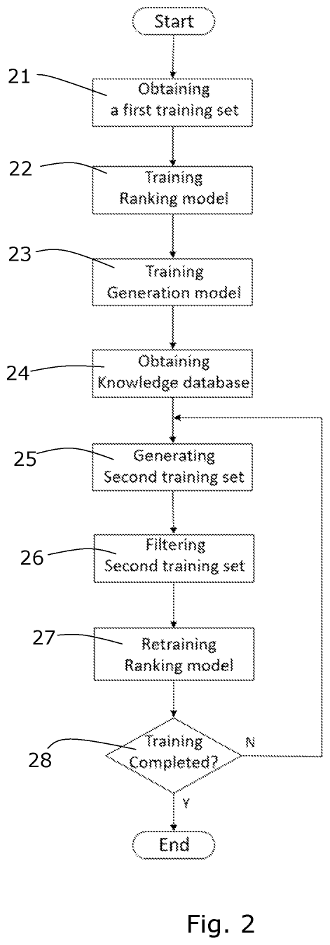

FIG. 2 shows the training method. The method is obtaining a first training set 21, and the first training set is used for training the ranking model 22 and for training the generation model 23. The method is obtaining a knowledge database 24, and the trained generation model is generating a second training set 25. The ranking model is the filtering the second training set 26 and the filtered second training set is then used to retrain the ranking model 27. If the training is completed 28 the ranking model now are ready to use, but if it is not completed the last three steps are repeated, a new second training set is generated and filtered and the ranking model is retrained again. Every iteration of this process will improve the performance, but less with each step, so going beyond three iterations will usually not lead to statistical significant improvements. Therefore, this process is usually repeated 3 times, but it may be repeated more than 3 times or less than 3 times depending on the number of chosen repetitions. The number of chosen repetitions is an input parameter for the method.

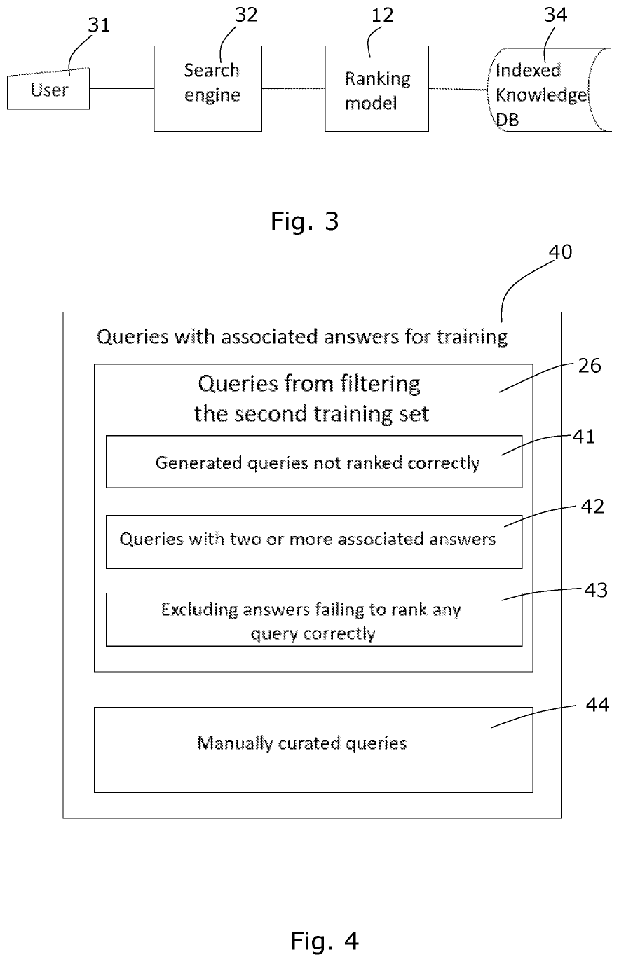

FIG. 3 shows that when a ranking model has been trained, it is used to find answers to user queries, the user 31 enters a query using a computer or a phone or other suitable device with a search engine 32, the search engine uses the ranking model 12 to get an answer for a query, and the ranking model finds the best answer for the query in an indexed knowledge database 34.

FIG. 4 illustrates the filtering step 26 in FIG. 1 is comprising three different filtering processes, the second training set may be filtered into generated queries not ranked correctly 41, by the ranking model, queries with two or more associated answers 42, and answers, where answers failing to rank any associated queries correctly 43 are excluded. Further FIG. 4 illustrates that the filtered queries are together with manually curated queries 44 forming a set of data 40 of queries with associated answers for retraining that is used for the retraining step 27. The manually curated queries is used in every retraining, while the filtered queries may be different from one retraining to the next retraining, because the generating step 25 is a stochastic process which may generate different queries in each iteration.

In the filtering step only one of the groups 41, 42, 42 may be included in the filtering. Alternatively two or three of the groups may be included. Which of the groups of filtered data that is used is decided by an input parameter for the method entered at the start of the method.

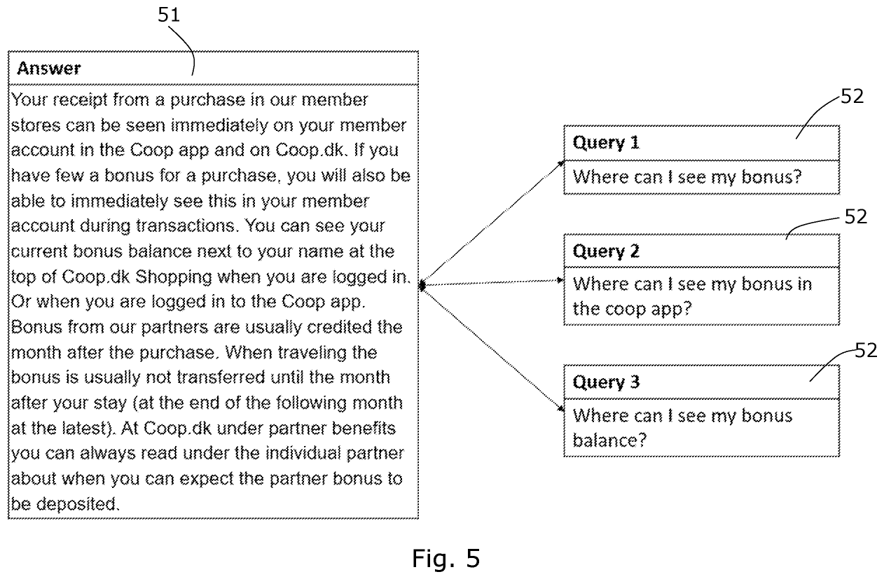

FIG. 5 illustrates an example of an answer 51, which the generation model have generated three queries 52. The answer is a section from a document about bonus for members and the generation model have generated queries asking about information contained in the answer. Therefore, each query is associated to one answer.

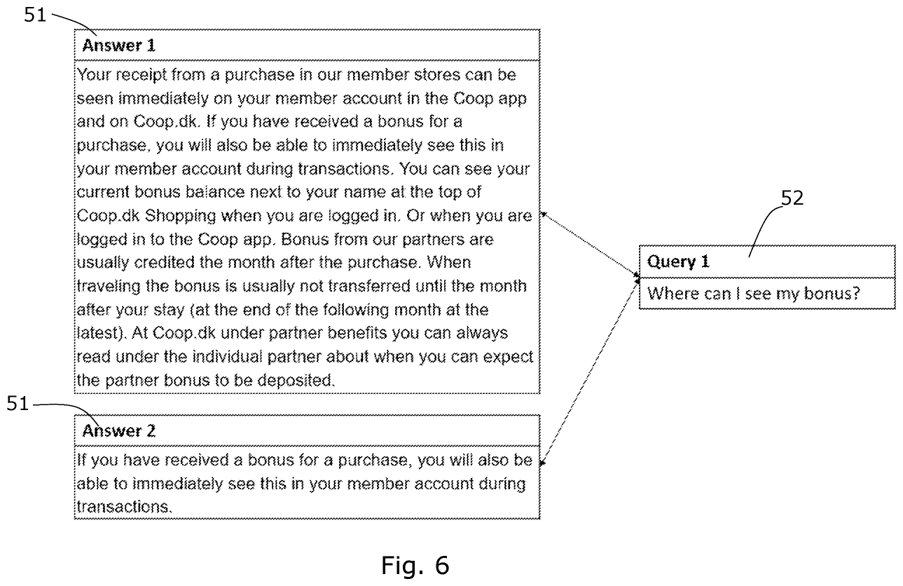

However, it is also possible to have queries associated with more answers as illustrated in FIG. 6. This may be because the same information is contained in different documents in the enterprises document database, or even the same document may be uploaded more times perhaps in different version for the enterprises intranet.

This may be discovered if queries generated for answer A is often classified by the ranking model as answer B and vice versa. If this happens beyond a certain threshold frequency then, it is an indicator that the two answers are similar. Generated questions for answers that meet the frequency threshold can therefore be associated with these two answers. The method can also be applied to identify three or more similar answers.

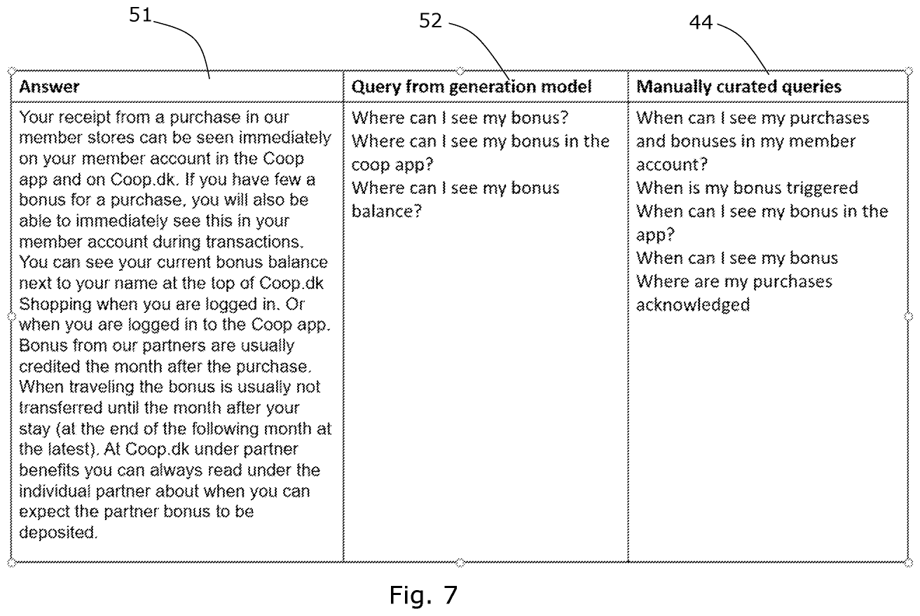

FIG. 7 illustrates that for an answer 51, queries 52 are generated by the generation model, but they may also be manually curated queries 44 for the training of the ranking model.

Description of the Ranking Model

The requirement for the query ranking machine learning model (the ranking model) is that given a query text sequence q, it should return a numerical relevance score for each of the document sections text sequences, the answers, d_1, . . . , d_n in the knowledge base. Therefore, the ranking model is simply a function that takes two text sequences as input and returns a numerical score: score_i=ranking(q, s_i) for section

As mentioned, the preferred used ranking model is based upon the CoIBERT architecture as described in the reference: Khattab, O. & Zaharia, M.

See FIG. 2(d) in the reference for a schematic. CoIBERT uses a pre-trained BERT model to form representation vectors for each of the tokens (sub-words) in the input sequences. CoIBERT uses late interaction, meaning that the representations are formed independently for the query and the sections. The latter more expensive step may be performed offline.

The score of the query against a section is computed by equation 3 in the reference, which finds the score for each token in the query as the maximum (inner product) over all tokens in the section. The final ranking score of the section is the sum of query token scores.

CoIBERT is fine-tuned on labelled data. The labelled data consists of a set of query section pairs. Ranking is formulated as a classification problem, where the scores for each section is converted into a probability through the softmax function and the model is trained with maximum likelihood, that is we maximize the probability of the associates in the training set.

When starting the method for a new enterprise without labelled data two strategies are used: transfer learning (train on data for other customers, the first training set) and train on query generation data, the second data set. These two approaches are fundamentally different because transfer learning is completely independent of the new knowledge base, whereas query generation uses the new knowledge base to generate queries from. In the method of the invention described herein, the transfer learning is done as the initial step of training 22 on the first dataset, and the training on query generation data is the retraining step 27, where the training continues from the weights obtained in the initial training step 22. When the retraining is repeated, it continues from the weight obtained in the previous retraining.

The CoIBERT parameters are fine tuned (the 110M BERT base parameters and the project matrix of size 768×128) using a validation set as a stopping criterion to optimise performance. The validation set could be from the generation model and validated by a human annotator.

Description of the Generation Model

The requirement for the generation model is that it can take a section as input and return a query. This sequence-to-sequence model is trained on a set of section query pairs obtained from previous customers or in the major languages from public benchmark datasets. Currently for Danish we use an in-house set of size approximately 10k.

The generation model preferable use the Prophet net sequence-to-sequence model as described in the reference: Qi et al. (2020), “ProphetNet: Predicting Future N-gram for Sequence-to-Sequence Pre-training”.

For Danish, it is pre-trained on Danish text corpus and fine-tuned on the in-house labelled dataset using validation text generation performance as a stopping criterion.

Use Cases

For the below use cases, the first training set has 2000 answers and in total 30000 queries.

The knowledge database used for the uses cases has 1250 answers. Further 3000 manually verified questions are included in the second data set for assessing the test performance.

Use Case 1

This use case illustrates the effect of training the ranking model on the full data set of generated questions compared to training the ranking model on a reduced training set with filtered data.

In this use case
The generation model generates 10 queries per answer from the knowledge database.
The filtering step is used to generate reduced training sets in three different ways:
   a) Remove easy queries. Filter out queries that the ranking model trained on the first dataset can answer in top 3. Hereby a first filtered group of queries with associated answers that the model cannot rank correctly is obtained.
   b) Remove redundant queries. Two queries are considered redundant if they have more than 50% overlap in top 10. Queries are removed iteratively until there is no more redundancy.
   c) Use the overlapping set between a) and b).
The ranking model is trained in different ways, it is trained on the full set and it is trained on the different subsets, and the results are compared for the different subsets and the full set of generated queries.

| | training | |
|---|---|---|
| Method | samples | Acc@3 |
| Zeroshot | 0 | 44.06 |
| x10 QG | 12448 | 53.79 |
| Hard questions | 4604 | 49.63 |
| No redundant questions | 4700 | 52 |
| Hard questions + | 2605 | 51.2 |
| No redundant questions | | |

This table shows that for the ranking model trained on the first dataset 44.06% of the generated queries the associated answer for this query is ranked in top 3. For the full set trained on the second training set 53.79% is ranked in top 3. Training on the filtered training sets, when trained on hard queries 49.63% is in top 3, trained on the set where redundant queries are removed 52% is in top 3, and trained on both hard queries with redundant queries removed 51.2 is in top 3.

Conclusions:
Not surprisingly, the best option is to use all the training data. That gives an almost 10% increase in top 3 accuracy performance compared to the ranking model trained on the first dataset.
By using less than 21% of the data (2605 versus 12488), we obtain a 7% increase in performance compared to the ranking model trained on the first dataset. For very large knowledge sources with millions of answers, it is impossible to train on 10× queries. There this method will become very useful in practice.

On very large training set, for instance with more than a million queries, it may take weeks to train on a full dataset. By the method of the invention by training only on a small filtered set, results almost as good as training on the full dataset can be obtained by a considerable smaller filtered training set.

Use Case 2

In this use case queries generated for two different answers are compared.

In this use case
The generation model generate 10 queries per answer from the knowledge database.
Each of these queries is ranked with the ranking model trained on the first dataset.
Top 1 rankings are compared for queries generated from two different answers. If these produce the same/most similar top 1 rankings, then the answers will be duplicate/redundant.

### EXAMPLE 1

Similar ranking=100% (100% same top 1 predictions)

=====Answer 1=========

“barsel.dk is a statutory scheme on the private labour market. all employers who do not have an agreement with an approved maternity scheme must pay into barsel.dk. barsel.dk aims to reduce expenses for private companies when they have employees on maternity leave. all companies covered by the scheme must pay into barsel.dk, even if some companies do not have employees who are or will be on maternity leave.”

====Answer 2=======

“all companies must pay into a maternity fund, either barsel. dk or another approved scheme. the amount depends on the total number of employees and not the number of female or male employees. the payment to barsel.dk is calculated on the basis of the number of employees. the amount is calculated from the payments to atp. per full-time employee, it costs DKK 1,150 per year in contribution to barsel.dk. students under the age of 25 are covered free of charge.”

In this example, for the queries generated for two different answers by the ranking model trained on the first dataset, all queries get the same answer as the top 1 answer. For instance, all queries generated for answer 2 actually are ranking answer 1 highest. In this case answer 1 and answer 2 are redundant and one of them may be filtered out.

### EXAMPLE 2

Similar ranking=80% (80% same top 1 predictions)

=====Answer 1=========

“you can change your subscription to an expert subscription yourself by selecting ‘company’ in the menu at the top and ‘correct information’. then select the ‘subscription’ tab and click on ‘change subscription’.

====Answer 2=======

Do you want to change your subscription? You can easily change your subscription if your needs change or you change cars. find the subscription you want in the future, write to us and we will take care of the practicalities. remember to state your customer number. follow the link below to write to us and change your subscription.”

In this example 80% of the queries generated for answer 1 and answer 2 get the same top 1 ranking. Therefore, the answers are redundant and one or both of the answers are filtered out.

Conclusion: It is non-trivial to identify near redundant content. Using query generation and a ranking model is as the examples show a powerful approach for this.

Hereby, redundant questions can be filtered out and not used for training the ranking model.

Use Case 3

In this use case is illustrated that the ranking model may be used to filter out and exclude queries with associated answers creating the third filtered group. In this use case, answers are identified for which their associated generated queries are not ranking the answer in top 20 by the ranking model trained on the first dataset.

In this use case
The generation model generates 10 queries per answer from the knowledge database.
With the ranking model trained on the first dataset, answers are ranked for all 10 questions generated for an answer.
Answers, where none of the generated queries predicts the original answer within top 20 are selected.

### EXAMPLES

The below four examples are associated answers which were not ranked in top 20 for the queries generated by the answer.

=====Footer=====

“Become a member Member benefits Member service Member terms Partner benefits Privacy policy Cooperation Recipes Consumer service Special offers Shopping Our products Sign up for newsletter Write to us Press contact Vacancies Visit”

====An answer containing just a link====

“https //www.loenguiden.dk/indhold/ferie-barsel-sygdom/barsel/”

=====Complex content====

“Have you received an SMS from us, and have you not ordered a free trailer? Sometimes our customers write the wrong phone number, and therefore it can happen that our confirmation of the reservation is sent to the wrong person. If you have received a message from us that does not belong to you, please send us an email at info@freetrailerdk. mark the message I have not ordered and write your phone number, as this is our only way to find the real customer who has written incorrectly. thanks in advance.”

=====Complex content====

“Contact us. Our customer support can be contacted by phone. we can La. help with querys about bills and guide the purchase of a charging solution on all weekdays. We are open Monday-Thursday at 9-16 and Friday at 9-15. If you urgently need help charging your electric car, call 70 27 05 77. Our customer support is open 24/7. You can also follow the link below if you want to report a fault with a charging station, write to us, order a new charging card, etc.”

Conclusions:
The first two examples show that this method can identify content which makes little meaning as an answer by itself.
The last two examples show that this method can identify complex content that is not easily being referred to through one generated query.

The first two examples are too simple to be meaningful and therefore are filtered out and excluded. The last two examples are too complicated for the ranking model to rank high for the generated queries and is filtered out and excluded.

In both situations, the method is useful for pointing to answers and questions that can be improved by human annotators.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

Glossary of Definitions

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus, a computer may include one or more physical processors or other computing devices or circuitry and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Database” also referred to as a “data store”, “data repository”, or “knowledge base” generally refers to an organized collection of data. The data is typically organized to model aspects of the real world in a way that supports processes obtaining information about the world from the data. Access to the data is generally provided by a “Database Management System” (DBMS) consisting of an individual computer software program or organized set of software programs that allow user to interact with one or more databases providing access to data stored in the database (although user access restrictions may be put in place to limit access to some portion of the data).

In another aspect, the DBMS provides various functions that allow entry, storage and retrieval of large quantities of information as well as ways to manage how that information is organized. A database is not generally portable across different DBMSs, but different DBMSs can interoperate by using standardized protocols and languages such as Structured Query Language (SQL), Open Database Connectivity (ODBC), Java Database Connectivity (JDBC), or Extensible Markup Language (XML) to allow a single application to work with more than one DBMS.

In another aspect, a database may implement “smart contracts” which include rules written in computer code that automatically execute specific actions when predetermined conditions have been met and verified. Examples of such actions include, but are not limited to, releasing funds to the appropriate parties, registering a vehicle, sending notifications, issuing a certificate of ownership transfer, and the like. The database may then be updated when the transactions specified in the rules encoded in the smart contract are completely executed. In another aspect, the transaction specified in the rolls may be irreversible and automatically executed without the possibility of manual intervention. In another aspect, only parties specified in the rules of the smart contract who have been granted permission may be notified or allowed to see the results.

Databases and their corresponding database management systems are often classified according to a particular database model they support. Examples include a DBMS that relies on the “relational model” for storing data, usually referred to as Relational Database Management Systems (RDBMS). Such systems commonly use some variation of SQL to perform functions which include querying, formatting, administering, and updating an RDBMS. Other examples of database models include the “object” model, chained model (such as in the case of a “blockchain” database), the “object-relational” model, the “file”, “indexed file” or “flat-file” models, the “hierarchical” model, the “network” model, the “document” model, the “XML” model using some variation of XML, the “entity-attribute-value” model, and others.

Examples of commercially available database management systems include PostgreSQL provided by the PostgreSQL Global Development Group; Microsoft SQL Server provided by the Microsoft Corporation of Redmond, Washington, USA; MySQL and various versions of the Oracle DBMS, often referred to as simply “Oracle” both separately offered by the Oracle Corporation of Redwood City, Calif., USA; the DBMS generally referred to as “SAP” provided by SAP SE of Walldorf, Germany; and the DB2 DBMS provided by the International Business Machines Corporation (IBM) of Armonk, N.Y., USA.

The database and the DBMS software may also be referred to collectively as a “database”. Similarly, the term “database” may also collectively refer to the database, the corresponding DBMS software, and a physical computer or collection of computers. Thus the term “database” may refer to the data, software for managing the data, and/or a physical computer that includes some or all of the data and/or the software for managing the data.

“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Module” or “Engine” generally refers to a collection of computational or logic circuits implemented in hardware, or to a series of logic or computational instructions expressed in executable, object, or source code, or any combination thereof, configured to perform tasks or implement processes. A module may be implemented in software maintained in volatile memory in a computer and executed by a processor or other circuit. A module may be implemented as software stored in an erasable/programmable nonvolatile memory and executed by a processor or processors. A module may be implanted as software coded into an Application Specific Information Integrated Circuit (ASIC). A module may be a collection of digital or analog circuits configured to control a machine to generate a desired outcome.

Modules may be executed on a single computer with one or more processors, or by multiple computers with multiple processors coupled together by a network. Separate aspects, computations, or functionality performed by a module may be executed by separate processors on separate computers, by the same processor on the same computer, or by different computers at different times.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDE1 (Synchronous Digital Elierarchy) protocol. The TCP/IP internet protocol suite may include application layer, transport layer, internet layer (including, e.g., IPv6), or the link layer.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projector a projecting device projecting a two-dimensional or three-dimensional image, any kind of printer, plotter, or similar device producing either two-dimensional or three-dimensional representations of the output fixed in any tangible medium (e.g. a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, Calif., USA. Other examples of commercially available processors include but are not limited to the X8 and Freescale Coldfire processors made by Motorola Corporation of Schaumburg, Ill., USA; the ARM processor and TEGRA System on a Chip (SoC) processors manufactured by Nvidia of Santa Clara, California, USA; the POWER7 processor manufactured by International Business Machines of White Plains, N.Y., USA; any of the FX, Phenom, Athlon, Sempron, or Opteron processors manufactured by Advanced Micro Devices of Sunnyvale, Calif., USA; or the Snapdragon SoC processors manufactured by Qalcomm of San Diego, Calif., USA.

A processor also includes Application-Specific Integrated Circuit (ASIC). An ASIC is an Integrated Circuit (IC) customized to perform a specific series of logical operations is controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data yielding a logical result (e.g. “true” or “false”). Processing activities may occur in multiple single processors on separate servers, on multiple processors in a single server with separate processors, or on multiple processors physically remote from one another in separate computing devices.

### REFERENCES

Khattab, O. & Zaharia, M. (2020) “CoIBERT: Efficient and Effective Passage Search via Contextualized Late Interaction over BERT”. SIGIR '20, Virtual Event, China.

Polosukhin et al. “Attention is All You Need”. NIPS 2017.

Qi et al. (2020), “ProphetNet: Predicting Future N-gram for Sequence-to-Sequence Pre-training”. EMNLP 2020.

The above-listed references are hereby incorporated by reference in their entirety.

We claim:

1. A method of training a query ranking machine learning model to provide an answer for a user query and/or query in a search engine, the method comprising:
training the query ranking machine learning model using a first training set that includes queries with associated answers using one or more processors of one or more computing devices;
training a query generation machine learning model for generating queries from answers based on the first training set using the one or more processors;
using the query generation machine learning model and the one or more processors to generate a second training set comprising queries with associated answers from a knowledge database comprising documents and answers;
using the query ranking machine learning model and the one or more processors to filter the generated queries with associated answers to generate a filtered group of queries with associated answers, wherein the filtered group is one or more of:
a first filtered group of one or more generated queries with associated answers that the query ranking machine learning model cannot rank correctly;
a second filtered group of one or more generated queries that have two or more associated answer; and
a third filtered group excluding one or more generated queries with associated answers, where for the answers none of the associated generated queries are ranked correctly;
using the one or more processors to retrain the query ranking machine learning model at least partially based on the filtered group of queries with associated answers from the second training set.

2. The method of claim 1, wherein the retraining of the query ranking machine learning model also is partially based on a group of manually curated queries with associated answers curated by human annotators.

3. The method of claim 1, wherein the queries with associated answers generated by the query generation machine learning model are curated at least partially by human annotators potentially aided by the filtering of the query ranking machine-learning model and included in the group of manually curated queries with associated answers.

4. The method of claim 1, wherein that one or more of the queries with associated answers excluded from the first filtered group, the second filtered group or the third filtered group are curated at least partially by human annotators and included in the group of manually curated queries with associated answers.

5. The method of claim 1, wherein a query is ranked correctly, when, using the query-ranking machine-learning model to calculate a score for each answer in a training set relative to the query, the highest scoring answer is an answer associated with the query.

6. The method of claim 1, wherein the method further comprising:
receiving a query from the user of the search engine, and
applying the query ranking machine-learning model to process the query for providing an answer to the user.

7. The method of claim 1, wherein the knowledge database is obtained by collecting documents and answers from an enterprise document collection.

8. The method of claim 1, wherein the first training set is obtained as a collection of two or more training sets created for a number of enterprises.

9. The method of claim 8, wherein the collection of two or more training sets is created at least partially by human annotators.

10. The method of claim 1, wherein the query generation machine learning model is comprising a sequence-to-sequence model.

11. The method of claim 1, wherein the query ranking machine-learning model is comprising a language model such as the BERT Transformer model.

12. The method of claim 1, wherein the generating, filtering and retraining steps is repeated zero, one, two, three, four, five or more times.

13. A search engine configured to obtain an answer for a user query, wherein the search engine is configured to receive a query from a user and apply a query ranking machine learning model to provide an answer to the user query, and wherein the query ranking machine learning model is trained according to claim 1.

14. A system configured to obtain an answer for a user query, wherein the system is configured to train a query ranking machine learning model and to apply a search engine for receiving a query from a user, wherein the system is configured to run the query ranking machine learning model to provide an answer to the query, and wherein the query ranking machine learning model is trained according to claim 1.

15. The system of claim 1, further comprising: repeating the generating, filtering and retraining steps zero or more times using the one or more processors.

16. The system of claim 1, further comprising: obtaining the first training set using the one or more processors.

17. The system of claim 1, further comprising: obtaining the knowledge database using the one or more processors.
